(19) United States
(12) Patent Application Publication
(10) Pub. No.: US 2006/0243695 A1
(43) Pub. Date: Nov. 2, 2006

(54) Disposable baby bottle device

(76) Inventor: Corwin Pearl Littell, Belle Isle, FL (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 11/411,661

(22) Filed: Apr. 26, 2006

Related U.S. Application Data
(60) Provisional application No. 60/675,790, filed on Apr. 28, 2005.

(51) Int. Cl. A61J 11/00; A61J 9/00; A61J 9/08

(52) U.S. Cl. 215/11.1; 215/11.3; 215/11.6; 215/11.4

(57) ABSTRACT

This invention is a disposable bottle device intended to disperse all types of pre-packaged ready to use liquids to all age groups of people and to animals through a nipple located on the disposable bottle device. The disposable bottle device has a sidewall that is all one piece, having ventilation holes spaced throughout the sidewall, and having a protective cap that is attached to the sidewall, which can be removed when the disposable bottle is ready for use. The nipple and a liquid impermeable liner are manufactured as one piece that is leak-proof and sterilized. A temperature strip is attached in a location to insure the proper temperature of the liquid inside the nipple/liner. A protective covering over the device acts as a safety seal to insure the integrity of the contents before purchase.

### SPECIFIC DATA RELATED TO THE INVENTION

This invention claims the benefit of U.S. provisional application No. 60/675,790 filed Apr. 28, 2005.

### BACKGROUND OF THE INVENTION

This present invention relates to disposable bottles and more particularly pertains to a disposable bottle for pre-packaged liquids that are sterilized, sealed and ready to use out of the package.

There are various problems and difficulties that have been encountered in providing people and animals of all age groups and, more specifically, babies with proper feeding by means of bottles, wherein bottles and their associated parts, as well as the contents should at all times be kept clean and sterilized. When a person or baby or animal is being fed at home or away from home the inherent problem is supplying liquid such as a food source or medication with the assurance that it is being administered from a sterile environment. Generally, the bottles are prepared and sterilized at home, which is time consuming and during which time the nipples and bottle parts are exposed to various contaminants both from being exposed to the environment and from the hands of the person that is preparing the bottle. Also, there is a possibility that not enough bottles have been prepared and the supply runs out when the bottle is needed the most, causing a chain reaction of events to happen such as a stop at the nearest restaurant without the time or facilities for sterilization thus potentially causing a biological disorder to occur such as projectile vomiting.

Even with the advent of disposable bottles, the problem of running out or the availability of sterilized milk or other sterilized liquids, such as formula or water, still exist. To the applicant's knowledge, there is no disposable baby bottle or any other type of disposable bottle available on the market today that can provide sterilized parts as well as sterilized food or liquids or medication in one package, where the bottle is pre-filled with any variety of liquids under ultimate, sterilized conditions, sealed as to not having to assemble any of the parts as described herein and being stored in such a way that maintains the integrity of being sterilized until the bottle as described herein is put into use.

Known prior art includes U.S. Pat. No. 4,678,092; U.S. Pat. No. 5,579,935; U.S. Pat. No. 3,777,025; U.S. Pat. No. 4,813,556; U.S. Pat. No. Des. 430,676; U.S. Pat. No. 6,737,091 B1. While these devices fulfill their respective, particular objectives and requirements, they do not disclose a new disposable bottle feeding device.

### SUMMARY OF THE INVENTION

The present invention discloses a device for containing sterilized liquids including medication, water, protein, vitamins and liquid food sources of all types for adults and babies and animals of all age groups, such as the elderly and the impoverished in remote areas and in disaster areas where supplies containing sterile liquids are not available.

The present invention includes a sidewall that is all one piece or can be comprised of two or more pieces depending on the version used, having ventilation holes spaced throughout the sidewall for various reasons, and having a protective cap that is attached to the sidewall and can be removed when the disposable bottle is ready for use, having a nipple/liner that is manufactured as all one piece or is made separate, depending on the version used but with the overall intention as to act as one piece, the nipple/liner being installed inside the sidewall and or the nipple being part of the sidewall depending on the version of disposable bottle used but being leak-proof and sterilized, having a temperature strip mounted on the nipple/liner or sidewall to insure the proper temperature of the liquid inside the nipple/liner, and further includes sterile liquids being disposed in the nipple/liner or sidewall in the disposable bottle device, and covering all or part of the disposable bottle device is a protective covering that acts as a safety seal to insure the integrity of the contents. None of the prior art includes the combination of elements of the present invention.

It is understood that such disposable, pre-filled, sterile bottles as stated herein will be obtained at stores, in supermarkets, in vending machines, in fast food restaurants and anywhere food and beverages are available for purchase.

In this respect, before explaining the embodiments of the invention in detail, it is to be understood that the invention is not limited in its application to the details of construction and or in the arrangements of the components set fourth in the following description of illustrated in the drawings. The invention is capable of other embodiments and is capable of being practiced and carried out in various ways depending on the application it is used in. Also, it is to be understood that the phraseology and terminology employed herein are for the purpose of description and should not be regarded as limiting.

It is the object of the present invention to provide a new disposable bottle device which has many of the advantages of the baby bottles mentioned in the prior art and many novel features that result in a new disposable bottle device which is not anticipated, rendered obvious, suggested, or even implied by any of the prior art.

Still another object of the present invention is to provided a new disposable bottle device for ingesting prepackaged liquids of all types such as medication, vitamins, formula or foods regardless of their consistency including juices, water and milk for people of all age groups, babies and animals.

Still yet another object of the present invention is to provide a new disposable bottle device that is easy and convenient to use.

Even still another object of the present invention is to provide a new disposable bottle device that is completely pre-assembled and ready to use.

Another object of the present invention is to provide a new disposable bottle device where the nipple and liner act as one structure which insures that there is no possibility of mold, mildew or bacteria growing on the inside of the nipple/liner.

Still another object of the present invention is to provide a new disposable bottle device that can be administered to a recipient without ever touching the nipple with the hands or fingers, which insures a safe, clean, germ free liquid source.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and description which are illustrated by the preferred embodiments of the invention.

### BRIEF DESCRIPTION OF THE DRAWINGS

The invention will be better understood by the following detailed description taken in conjunction with the drawings in which:

FIG. 1 is a front cross-sectioned view of a new disposable bottle device according to the present invention;

FIG. 2 is a front cross-sectioned view of the disposable bottle with some liquid drawn out of the inner liner;

FIG. 3 is a front cross-sectioned view of the one-piece inner liner and nipple for the disposable bottle;

FIG. 4 is a front cross-sectioned view of a two-piece sidewall for the disposable bottle;

FIG. 5 is a front cross-sectioned view of a one-piece sidewall for the disposable bottle;

FIG. 6 is a front cross-sectioned view of a disposable bottle showing a different method of attaching the nipple to the liner; and

FIG. 7 is a front cross-sectioned view of a disposable bottle that is all one piece, having no inner liner where the sidewall and the nipple act as one in the same structure

### DETAILED DESCRIPTION OF THE INVENTION

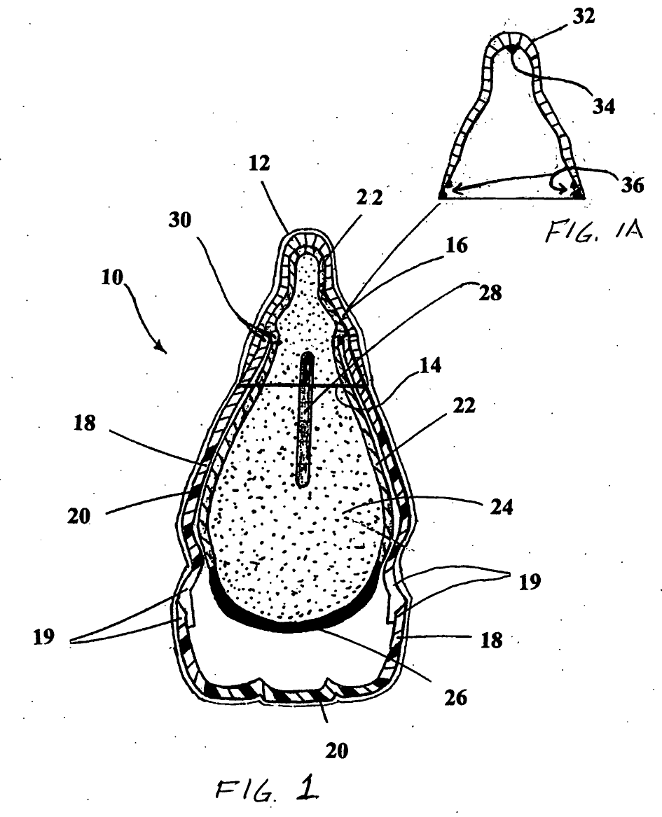

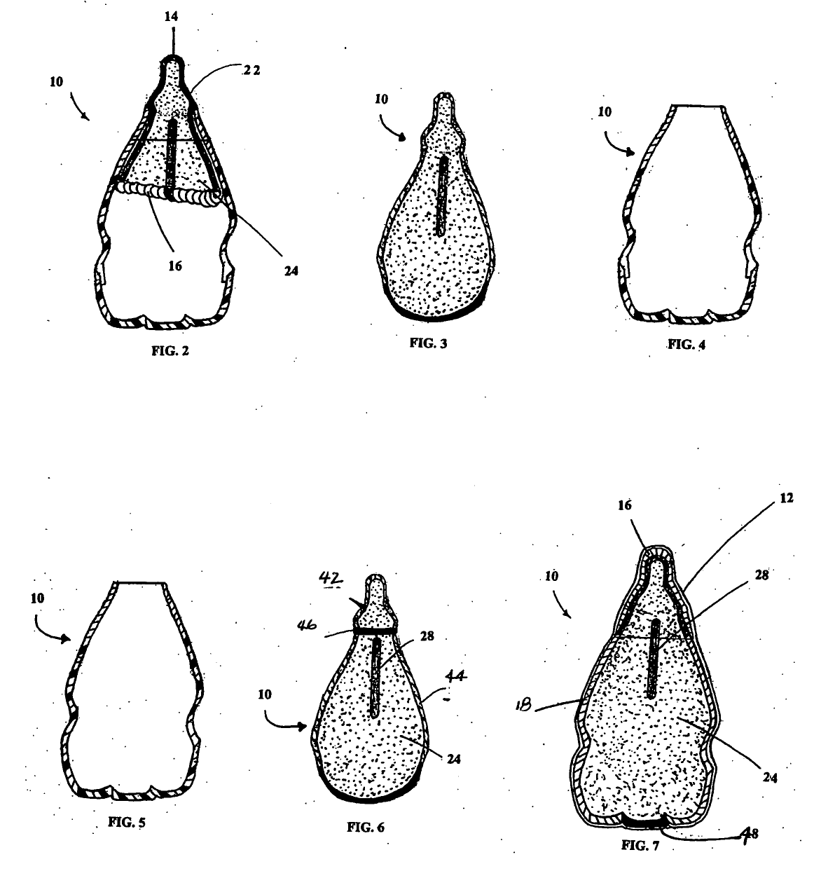

Referring to FIG. 1, there is shown a front, cross-sectioned view of a disposable bottle device 10 according to one embodiment of the present invention. A thin layer of plastic or other pliable material 12 that can cover all parts of device 10 or just the protective cap 16 of the disposable bottle device functions as a protective safety wrap intended to be removed prior to use for the purpose of protecting the over-all integrity of the disposable bottle device and it's contents prior to purchase. A zipper-seal 14 in the same manner as a safety seal that is installed on a new bottle top on a common plastic disposable soda container can be used to insure the integrity of the disposable bottle and its contents while providing easy opening access. FIG. 1A is a front, cross-sectioned view of the protective cap 16 comprised of a single piece 32 or multiple pieces of ridged or pliable material such as plastic generally made using an injection mold, thus allowing close tolerances so that the protective cap would snap into place by means of ridges or extrusions 36, or by a means that is determined by the manufacturer which would be suitable for this device when it is affixed to the device sidewall 18 for the purposes of preventing it from falling off the sidewall 18 when the disposable bottle is not being used. The cap 16 also protects the nipple 22 from damage and contact with germs, bacteria or any substance that would harm or be foreign to the user or contents of the disposable bottle. A protrusion 34 acts as a stopper when the protective cap 32 is installed on the sidewall 18 which in turn puts downward pressure on the feeding hole which is located at the top of the nipple as shown in FIG. 2 at 14. When the protective cap 16 is put back on a partially used disposable bottle and snapped into place the nipple will not leak since the cap is pressed against the nipple top blocking hole 14.

A two-piece sidewall 18 of material such as plastic, silicone, rubber, glass, aluminum, metal or any other pliable or rigid material that would be suitable for this invention including being made of a material that is determined by need, or environment, or regulation, or cost, or health issues forms a bottom support for the bottle or device 10. The side wall 18 is joined for the purposes of this illustration at 19 but can be joined or separated at any location of the sidewall whether it be horizontally at the bottom or top or middle of sidewall 18, or vertically down the middle from top to bottom of the sidewall which can be determined by the manufacturer or individual needs, but is intended to be joined together in a fixed fashion for the purpose of supporting and protecting the entire structure 10 from outside damage or contamination in the course of normal use, and for the purposes of housing the nipple/liner 22 before or after it is filled with prepackaged liquids 24. Openings 20 in the sidewall 18 are located throughout the sidewall 18 but are not limited to any particular location or size or shape on the sidewall 18 and are intended to release any vacuum buildup that might be created when the bottle is being used including submerging the sidewall 18 in a liquid such as water for the purpose of heating or cooling the contents 24 that are inside the nipple/liner 22 thus allowing a liquid such as water to directly heat or cool the nipple/liner 22 and contents 24. Openings 20 are also used when draining a liquid used to heat or cool contents 24 out of the sidewall 18 once the contents 24 and nipple/liner 22 have been heated or cooled to the preferred temperature. The nipple/liner 22 can be made of plastic or silicone or rubber or any other pliable material that is nontoxic, sterilized and suitable for this invention. Nipple/liner 22 is one continuous part that functions as a container to store liquids 24 of all types including medication, vitamins, formula or foods regardless of their consistency including juices, water and milk all of which are prepackaged in the nipple/liner 22 at the manufacture through the filler area 26 in the liner. Filler area 26 is not limited to this exact location on the liner as the opening could be installed anywhere on the nipple/liner 22. Once the nipple/liner 22 has been filled with the desired liquid from the manufacturer to a capacity and volume that would minimize or eliminate any air that would be trapped inside the nipple/liner 22, the opening in the nipple/liner 26 can be sealed with glue or heat or fusion or stamping or cauterization or clamping or tying or folding or pressure or any other type of adhesion that is suitable for this invention that will provide a leak proof environment for the liquid 24 that is stored inside the nipple/liner 22 to insure the integrity of the nipple/liner 22 as well as the overall use of the disposable bottle device 10. Another use for the nipple/liner 22 is to form the nipple portion of the nipple/liner 22 which can be made from a different and thicker or thinner material other than the material of the liquid storing portion of the liner 22. In such a case, the nipple material would be molded into the liner material and the liner material into the nipple material in such away that it would function as one piece. However, the nipple could be made of the same material and thickness as liner 22 depending on the application that the nipple/liner is being used for. A heat strip 28 is attached to the nipple/liner 22 either on the inside or outside of the nipple/liner, or to the inside or the outside of the sidewall 18 for the purpose of showing temperature of the liquid 24. The strip 28 may be located at the general area 30 of the nipple/liner where 22 nipple/liner is attached to the sidewall 18 by means of adhesive or by glue or by heat or fusion or by snapping it or screwing it together in some way as to secure the nipple/liner 22 to the sidewall 18 when the device or bottle 10 is being used under normal conditions.

FIG. 2 illustrates how the nipple/liner 22 collapses when some of the liquid 24 has been extracted by suction applied via hole 14. The liner 22 will fold, or gather, to roll upward as shown at 16 thus preventing air from getting into the liquid 24 and eliminating or greatly reducing excess air intake to the user ingesting the liquid 24.

FIG. 3 illustrates a filled liner 22 in the inventive one piece nipple/liner configuration.

FIG. 4 illustrates one form of construction of the outer sidewall or support 18.

FIG. 5 illustrates a one-piece sidewall 18 construction for the disposable bottle device which has the same overall function as the two-piece sidewall of FIG. 4 but is intended to allow the nipple/liner 22 to be inserted from the top of the sidewall as opposed to the bottom of the sidewall 10.

FIG. 6 illustrates an alternate embodiment in which the nipple/liner 22 is formed as a nipple 42 attached at 46 to a liner 44 after filling the liner. The nipple and liner can be sealed together at 16 or other appropriate location with glue, heat, fusion, stamping, cauterization, clamping, tying, folding, pressure or any other type of adhesion that is suitable for this invention in a way as to be used as one structure, and in a way that will provide a leak proof environment for the liquid 24 that is stored inside the liner 44.

FIG. 7 illustrates a further embodiment of the invention having some of the same characteristics as in FIG. 1 including cover 12, the protective cap 16 and heat strip 28, all having the same functions as those parts noted in FIG. 1. The sidewall 18 has a nipple 42 built into it as part of the sidewall and made of the same or different material, and the nipple could be of a different thickness as the sidewall 18 but acting as one and the same structure, and could be attached or molded or glued or fused in such a way that would make the operation of the nipple function as one integral part of the sidewall, having no liner, meaning the liquid is placed inside the sidewall in a sterile environment and is drawn out of the disposable bottle through a hole at the top of the nipple, and having a filler hole 48 somewhere in the nipple/sidewall 18 so that liquid can be injected.

The invention and its advantages will be understood from the forgoing description and it will be apparent that various changes may be made in the form, construction and arrangement of the parts of the invention without departing from the spirit and scope thereof or sacrificing its material advantages, the arrangement hereinbefore described being merely by way of example, and I do not wish to be restricted to the specific form shown or uses mentioned, except as defined in the accompanying claims.

What is claimed is:

1. A unitary liquid storage and dispensing container comprising:
a flexible liner;
a nipple attached in non-removable form to the liner; and
a generally rigid shell adapted for supporting the nipple and liner combination.

2. The container of claim 1 wherein the nipple is fixed to the liner after filling of the liner with liquid.

3. The container of claim 1 wherein liquid is injected into the nipple and liner combination through a hole formed in the nipple, the hole functioning further to allow liquid to be withdrawn from the container.

4. The container of claim 1 and including a generally rigid cap coupled to the shell and extending in protective alignment over the nipple.

5. The container of claim 4 wherein the cap is removably attached in sealing relationship with the shell.

6. The container of claim 5 wherein the shell is provided with at least one vent hole to allow air to enter a space between the shell and liner as liquid is withdrawn from the liner so as to allow the liner to collapse.

7. The container of claim 6 and including a bottom portion formed separately from a sidewall portion of the shell wherein the liner and nipple combination may be inserted into the shell prior to attachment of the bottom portion.

8. The container of claim 6 wherein the nipple and liner combination is inserted into the shell prior to filling of the liner with liquid.

9. A unitary liquid storage and dispensing container comprising:
a flexible liner;
a generally rigid shell adapted for supporting the liner, the shell having an open end to which an open end of the liner is attached; and
a nipple coupled in non-removable form to the open end of the shell.

10. The container of claim 9 and including a generally rigid cap releasably coupled to the shell and extending in protective relationship over the nipple.

11. The container of claim 10 and including a removable, flexible plastic cover extending about the shell and sealingly engaged with the cap.
